(19) United States
(12) Patent Application Publication
(10) Pub. No.: US 2009/0251418 A1
(43) Pub. Date: Oct. 8, 2009

(54) METHOD OF CONFIGURING AN IDLE SCREEN AND DEVICE USING THE SAME

(75) Inventor: Sheng Yao Cho, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/061,678

(22) Filed: Apr. 3, 2008

(51) Int. Cl. G06F 3/02; G09G 5/00; G06F 3/033; G06F 3/048; G06F 3/14; G06F 3/041

(52) U.S. Cl. 345/169; 455/566; 345/156; 345/184; 345/173; 715/864; 715/840

(57) ABSTRACT

A method of operating a mobile phone implementing a plurality of functions is provided. A communication mode is provided in the mobile phone, when in the communication mode, a communication control interface is configured as an idle screen when none of the functions is in use. A function application mode is provided in the mobile phone, when in the function application mode, an application control interface corresponding to one of the functions is configured as the idle screen when the one of the functions is in use. A first selection is received, directing the mobile phone to switch between the communication mode and the function application mode. The mobile phone is operated in the communication mode or the function application mode according to the selection.

### BACKGROUND

The invention relates to device control, and in particular to configuration of an idle screen in an electronic device.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Mobile phones implementing various applications (multi-application mobile phones) have been developed. For example, a mobile phone can operate as an MP3 player, PoC (Push-to-talk) terminal, radio, camera, video player, video recorder and/or a schedule organizer.

Multi-application mobile phones offer several potential advantages over multiple individual devices. Multi-application mobile phones, however, also suffer from some drawbacks, for example, complexity of operation of the mobile phone.

Generally, applications implemented in a mobile phone are arranged in a hierarchical menu.

The hierarchical menu, however, is displayed on multiple screens. To execute an application, a user scrolls through the hierarchical menu to execute the desired function. The operations are complicated due to complex key operations.

For example, in order to execute a radio player application, multiple screens are scrolled through in the hierarchical menu. Referring to FIG. 1, an idle screen specified in layer 11 is displayed by default. A main menu screen specified in layer 12 is displayed in response to a user command. When an item, such as a ‘menu’ item, is selected from the main menu, contents of the selected item are further displayed correspondingly. For example, an ‘entertainment’ item, associated with a plurality of selectable entries corresponding to various applications, is displayed. The “multimedia” item comprises entries corresponding to multimedia-related application. The ‘FM radio’ application is executed by scrolling through 4 menu layers, thus, operation is inconvenient.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of operating a mobile phone implementing a plurality of functions is provided. A communication mode is provided in the mobile phone, when operating in the communication mode, a communication control interface is configured as an idle screen when none of the functions is in use. A function application mode is provided in the mobile phone, when operating in the function application mode, an application control interface corresponding to one of the functions is configured as the idle screen when the one of the functions is in use. A selection is received, directing the mobile phone to switch between the communication mode and the function application mode. The mobile phone is operated in the communication mode or the function application mode according to the selection.

A mobile phone is provided for implementing a plurality of functions. A processor operates the mobile phone in a communication mode or a function application mode, when operates in the communication mode, a communication control interface is configured as an idle screen when none of the functions is in use; when operating in the function application mode, an application control interface corresponding to one of the functions is configured as the idle screen when the one of the functions is in use. An input device receives a user selection of the communication mode or the function application mode. A display device displays the communication control interface or the application control interface as the idle screen.

### BRIEF DESCRIPTION OF DRAWINGS

The invention can be more fully understood by reading the subsequent detailed description and examples with references made to the accompanying drawings, wherein:

FIG. 1 shows a schematic view of a conventional hierarchical menu.

FIG. 2 is a schematic view of an embodiment of a portable device;

FIG. 3 is a schematic view of an embodiment of a hierarchical menu;

FIG. 4 is a flowchart of an embodiment of a method of configuring an idle screen of an electronic device;

FIGS. 5A-5E are embodiments of a portable device;

FIG. 6 shows a schematic view of an embodiment of screen base mechanism; and

FIG. 7 shows a schematic view of another embodiment of a screen based mechanism.

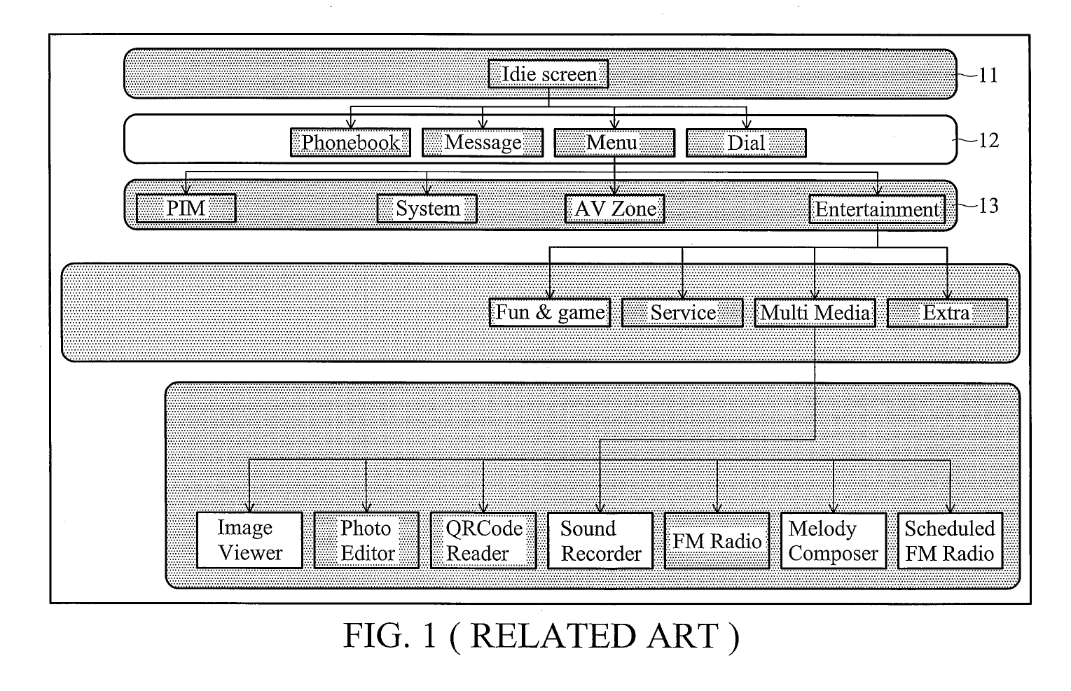

### DETAILED DESCRIPTION

One or more specific embodiments of the invention are described in the following. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constrains, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

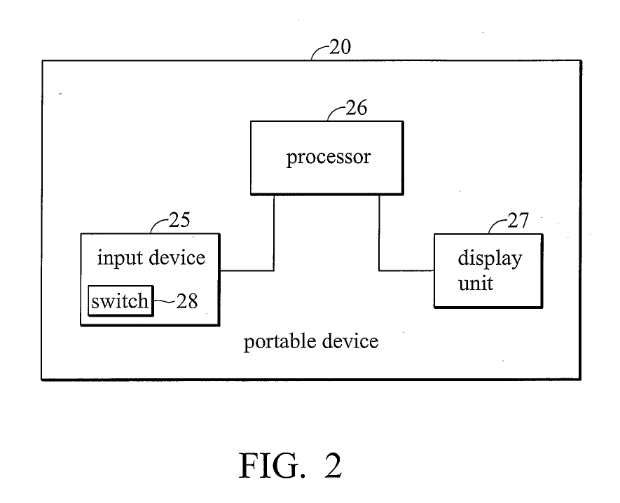

FIG. 2 is a schematic view of an embodiment of a mobile phone. A mobile phone 20 comprises an input device 25, a processor 26, and a display unit 27. The processor 26 operates the mobile phone 20 in a communication mode or a function application mode. When the processor 26 operates the mobile phone 20 in the communication mode, a communication control interface is configured as an idle screen when none of the functions is in use. When the processor 26 operates the mobile phone 20 in the function application mode, an application control interface corresponding to one of the functions is configured as the idle screen when the one of the functions is in use. The input device 25 receives a selection from the communication control interface and the application control interface. The display unit 27 displays the communication control interface or application control interface specified in the selection as an idle screen.

The input device 25 can be any device capable of receiving a user selection of the communication mode or the function application mode, such as a jog-dial, a click wheel, and up/down/right/left directional keys. The input device 25 can further comprise a motion detector for detecting whether the mobile phone 20 is in motion. When the mobile phone 20 is moved in a predetermined way, a signal, indicating that the communication control interface or the application control interface is to be implemented, is generated.

The input device 25 further comprises a switch 28 directing the display unit 27 to display a control interface of the communication mode.

The display device 27 displays the communication control interface or the application control interface as the idle screen.

A touch screen can implement the display unit 27 and the input device 25. In this case, the touch screen further displays a communication icon and at least one application icon, wherein the communication control interface is displayed when the communication icon is selected, and the corresponding application control interface is displayed when one of the at least one application icon is selected.

When the mobile phone 20 is operated in the communication mode, the communication control interface is displayed as an idle screen by default. Similarly, when the mobile phone 20 is operated in the function application mode, the application control interface is displayed as an idle screen by default.

The function application mode implements one of the following different device functions: MP3 player, PoC (Push-to-talk) terminal, radio player, camera, video player, video recorder and a schedule organizer. Functions performed by the function application mode can be arranged in a hierarchical menu.

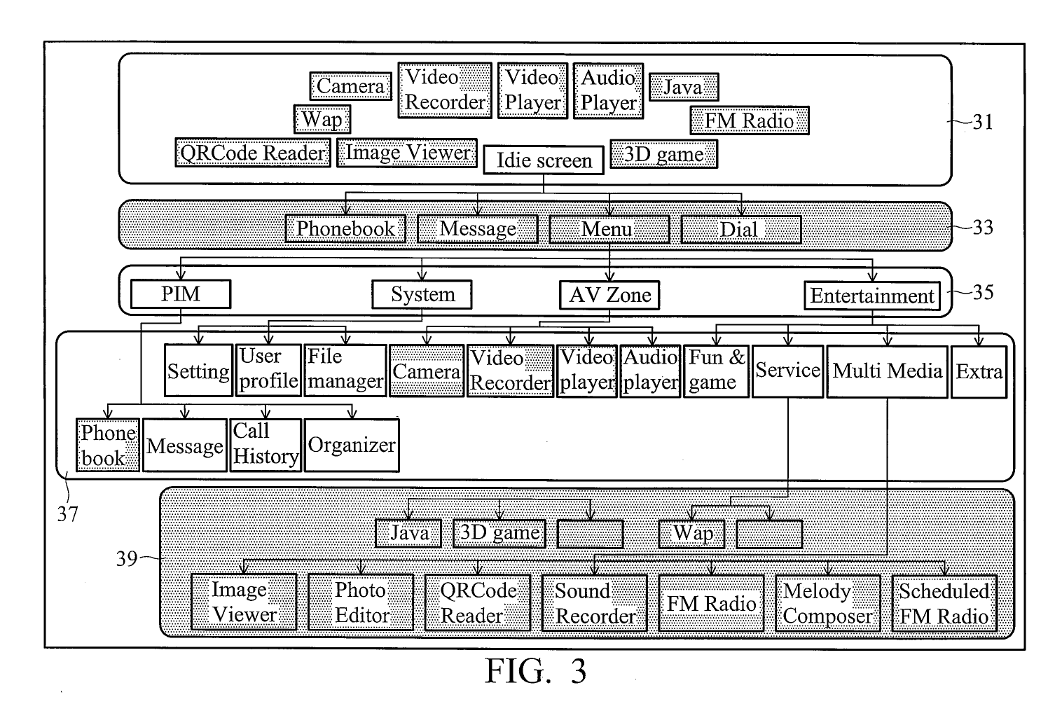

FIG. 3 is a schematic view of an embodiment of a hierarchical menu. The hierarchical menu comprises layers 31, 33, 35, 37, and 39. Various control interfaces can be set as candidates of an idle screen specified in layer 31. A candidate set as the idle screen is displayed by default. When a control interface, such as the “FM radio” control interface is set as the idle screen, the FM radio function can be executed by manipulating entries shown on the idle screen (FM radio control interface). Thus, the desired function is immediately available and scrolling through multiple screens of the hierarchical menu to execute the FM radio application is eliminated.

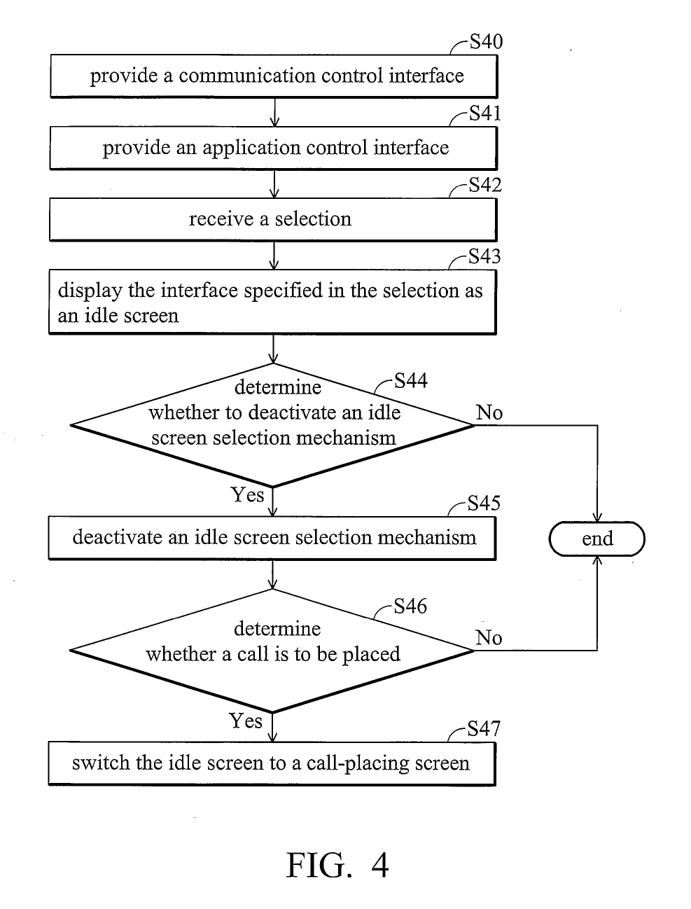

FIG. 4 is a flowchart of an embodiment of a method of configuring an idle screen of an electronic device. A communication control interface, associated with entries for functions performed by a communication mode, is provided (step S40). When the electronic device operates in the communication mode, the communication control interface is configured as an idle screen when none of the functions is in use. An application control interface, associated with entries for functions performed by a function application mode, is provided (step S41). When the electronic device operates in the function application mode, the application control interface corresponding to one of the functions is configured as the idle screen when the one of the functions is in use. A selection is received (step S42), indicating the communication control interface or the application control interface is selected. The communication control interface or application control interface specified in the selection is displayed as an idle screen (step S43). It is determined whether to deactivate an idle screen selection mechanism (such as the input device 25 of FIG. 2), and if so, the method proceeds to step S45, otherwise, the method ends. In step S45, an idle screen selection mechanism is deactivated. The idle screen stays in the control interface selected in step S42, even when the idle screen selection mechanism is accidentally manipulated. In step S46, it is determined whether a call is to be placed, and if so, the method proceeds to step S47, otherwise, the method ends. In step S47, the idle screen is switched to a control interface of the communication mode, for directly placing a call.

A number of exemplary embodiments implementing a portable device, such as a mobile phone, of the invention are described in the following.

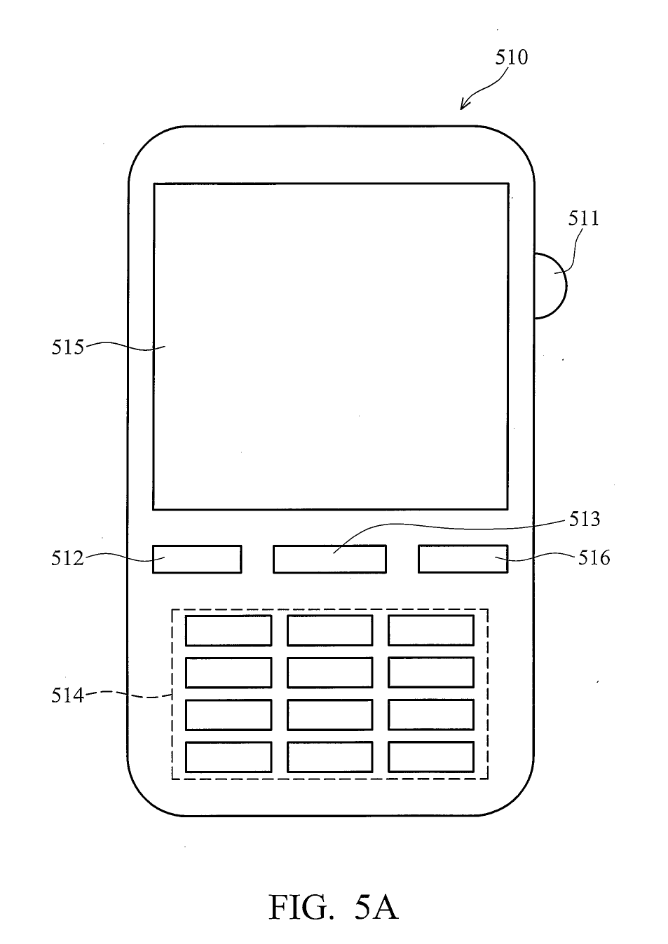

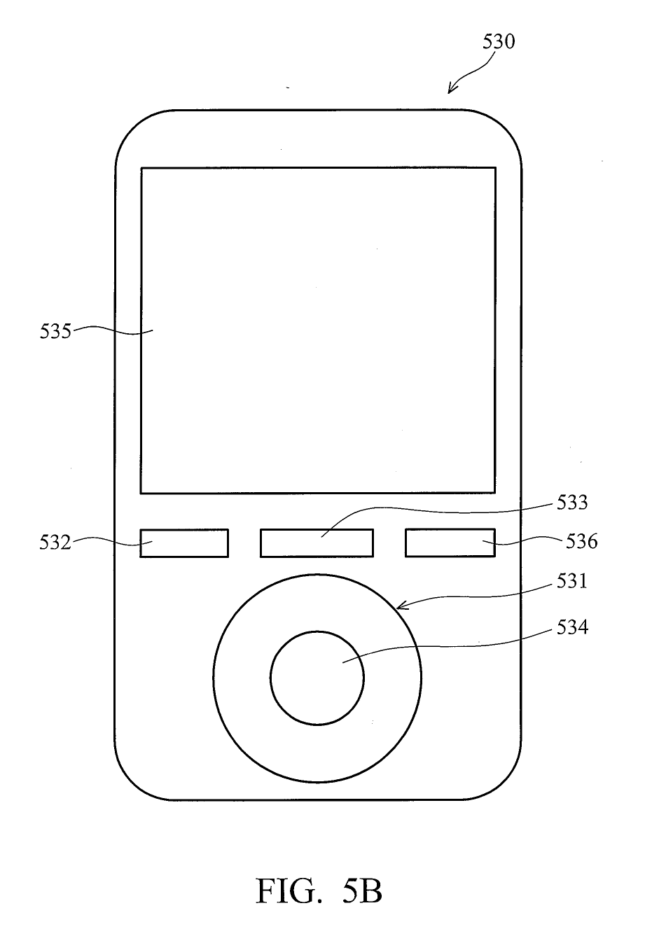

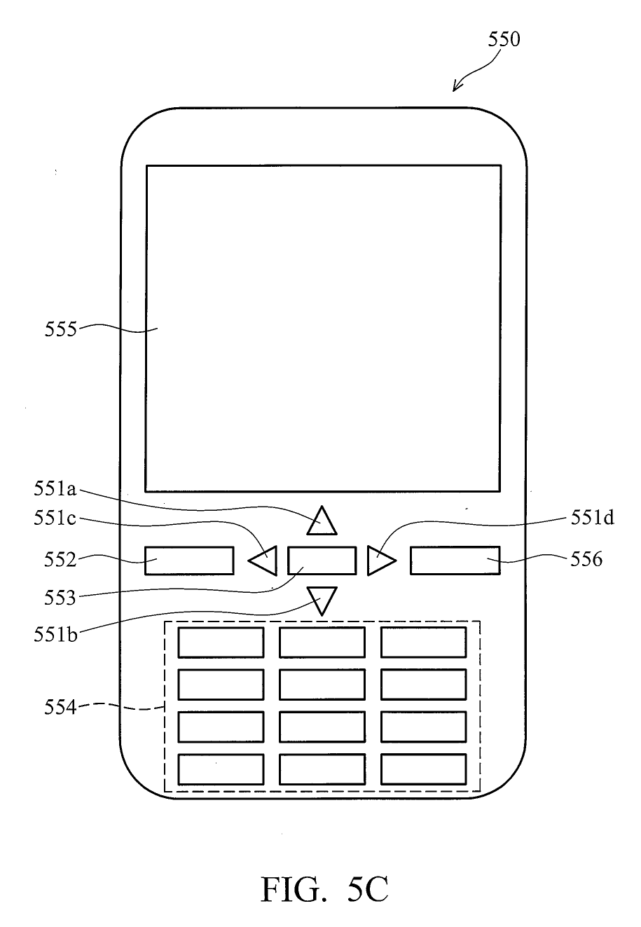

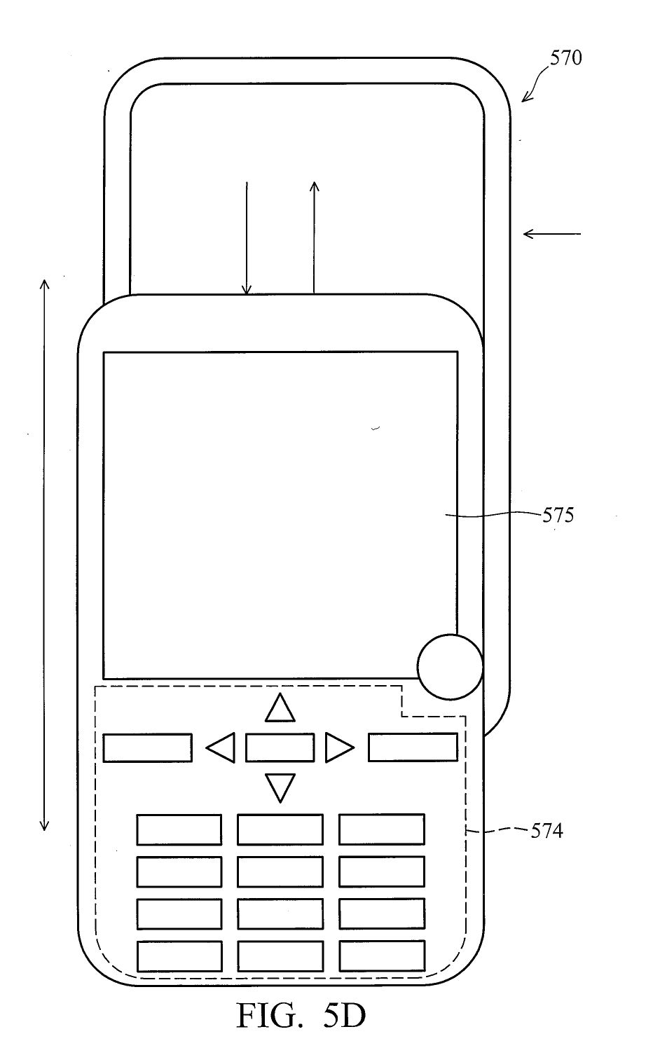

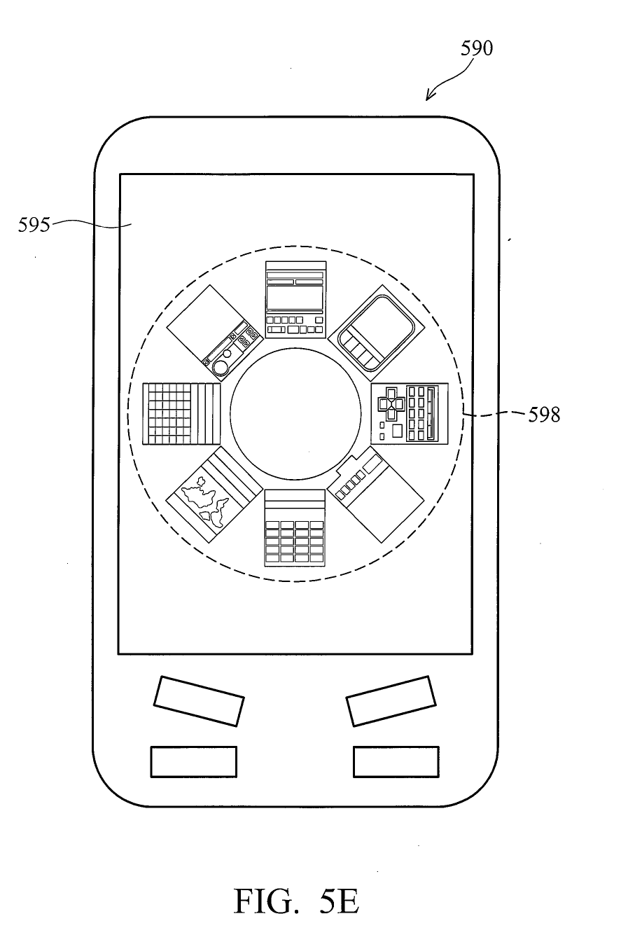

FIG. 5A is an embodiment of a portable device. A portable device 510 can be a mobile phone. The portable device 510 comprises a display screen 515, a jog-dial 511, function keys 512, 516 and 513, and numeric keys 514. Function key 516 or any one of the numeric keys 514 can operate as a mode switch key, when manipulated, directs the mobile phone to switch between a communication mode and a function application mode. When the mobile phone is switched to the function application mode, the jog-dial 511 is used for selecting one of a plurality of applications and one application control interface corresponding to the selected application is assigned as an idle screen of portable device 510. In other words, the selected control interface which is set as the idle screen of the portable device 51 can be the communication control interface of the communication mode, or the application control interface of one of the applications operating under the function application mode. For example, the application can be an MP3 player, PoC (Push-to-talk) terminal, radio, camera, video player, video recorder and a schedule organizer. When a control interface, such as the “FM radio” control interface is set as the idle screen, functions of the FM radio can be executed by manipulating entries shown on the idle screen (FM radio control interface). Function key 512 operates as a switch directing the display screen 515 to display a control interface of the communication mode. Function key 513, when manipulated, directs the display screen 515 to display a function menu of the portable device 510. For example, when the function key 513 is pressed, a function menu of the portable device 510 is shown. FIG. 8 illustrates an embodiment of the function menu displayed on the display screen 515, comprising icons representing different functions of the portable device 510, such games, media database, applications, messages, camera, browser, calendar, contact, and settings. At least one of the numeric keys 514 can operate as a screen lock deactivating the jog-dial 511.

As described, function key 516 or any one of the numeric keys 514 can operate as a mode switch key, when manipulated, directs the mobile phone to switch between a communication mode and a function application mode; and at least one of the numeric keys 514 can operate as a screen lock deactivating the jog-dial 511. It should be noted that different numeric keys 514 can be used as the mode switch key and the screen lock, respectively.

FIG. 5B is an embodiment of a portable device. A portable device 530 can be a mobile phone. The portable device 510 comprises a display screen 535, a click wheel 531, function keys 532, 536 and 533, and click wheel lock 534. Function key 536 can operate as a mode switch key, when manipulated, directs the mobile phone to switch between a communication mode and a function application mode. When the mobile phone is switched to the function application mode, the click wheel 531 is used for selecting one of a plurality of applications and one application control interface corresponding to the selected application is assigned as an idle screen of portable device 530. In other words, the selected control interface which is set as the idle screen of the portable device can be the communication control interface of the communication mode, or the application control interface of one of the applications operating under the function application mode. For example, the application can be an MP3 player, PoC (Push-to-talk) terminal, radio, camera, video player, video recorder and a schedule organizer. When a control interface, such as the “FM radio” control interface is set as the idle screen, functions of the FM radio can be executed by manipulating entries shown on the idle screen (FM radio control interface). Function key 532 operates as a switch directing the display screen 535 to display a control interface of the communication mode. Function key 533, when manipulated, directs the display screen 535 to display a function menu of the portable device 530. For example, when the function key 533 is pressed, a function menu of the portable device 530 is shown. FIG. 8 illustrates an embodiment of the function menu displayed on the display screen 535, comprising icons representing different functions of the portable device 530, such games, media database, applications, messages, camera, browser, calendar, contact, and settings. The click wheel lock 534 operates as a screen lock deactivating the click wheel 531.

FIG. 5C is an embodiment of a portable device. A portable device 550 can be a mobile phone. The portable device 550 comprises a display screen 555, up/down/left/right directional keys 551a, 551b, 551c, 551d, function keys 552, 556 and 553, and numeric keys 554. Function key 556 or any one of the numeric keys 554 can operate as a mode switch key, when manipulated, directs the mobile phone to switch between a communication mode and a function application mode. When the mobile phone is switched to the function application mode, the up/down/left/right directional keys 551a, 551b, 551c, 551d are used for selecting one of a plurality of applications and one application control interface corresponding to the selected application is assigned as an idle screen of portable device 550. In other words, the selected control interface which is set as the idle screen of the portable device can be the communication control interface of the communication mode, or the application control interface of one of the applications operating under the function application mode. For example, the application can be an MP3 player, PoC (Push-to-talk) terminal, radio, camera, video player, video recorder and a schedule organizer. When a control interface, such as the “FM radio” control interface is set as the idle screen, functions of the FM radio can be executed by manipulating entries shown on the idle screen (FM radio control interface). Function key 552 operates as a switch directing the display screen 555 to display a control interface of the communication mode. Function key 553, when manipulated, directs the display screen 555 to display a function menu of the portable device 550. For example, when the function key 553 is pressed, a function menu of the portable device 550 is shown. FIG. 8 illustrates an embodiment of the function menu displayed on the display screen 555, comprising icons representing different functions of the portable device 550, such games, media database, applications, messages, camera, browser, calendar, contact, and settings. At least one of the numeric keys 554 can operates as a screen lock deactivating the up/down/left/right directional keys 551a, 551b, 551c, 551d.

As described, function key 556 or any one of the numeric keys 554 can operate as a mode switch key, when manipulated, directs the mobile phone to switch between a communication mode and a function application mode; and at least one of the numeric keys 554 can operates as a screen lock deactivating the up/down/left/right directional keys 551a, 551b, 551c, 551d. It should be noted that different numeric keys 554 can be used as the mode switch key and the screen lock, respectively.

FIG. 5D is an embodiment of a portable device. A portable device 570 can be a mobile phone. The portable device 570 comprises a display screen 575 and a keypad 574. The portable device 570 also comprises a built-in motion detector (not shown). Any one key of the keypad 574 can operate as a mode switch key, when manipulated, directs the mobile phone to switch between a communication mode and a function application mode. When the mobile phone is switched to the function application mode, the motion detector is used for selecting one of a plurality of applications and one application control interface corresponding to the selected application is assigned as an idle screen of portable device 570. For example, when the portable device 570 is moved upward, the mobile phone is switched to function application mode of an MP3 player, when the portable device 570 is moved downward, the mobile phone is switched to function application mode of a camera. In other words, the selected control interface which is set as the idle screen of the portable device can be the communication control interface of the communication mode, or the application control interface of one of the applications operating under the function application mode. For example, the application can be an MP3 player, PoC (Push-to-talk) terminal, radio, camera, video player, video recorder and a schedule organizer. When a control interface, such as the “FM radio” control interface is set as the idle screen, functions of the FM radio can be executed by manipulating entries shown on the idle screen (FM radio control interface). One key of keypad 574 operates as a switch directing the display screen 575 to display a control interface of the communication mode. Another key of keypad 574, when manipulated, directs the display screen 575 to display a function menu of the portable device 570. For example, when the particular key of keypad 574 is pressed, a function menu of the portable device 570 is shown. FIG. 8 illustrates an embodiment of the function menu displayed on the display screen 575, comprising icons representing different functions of the portable device 570, such games, media database, applications, messages, camera, browser, calendar, contact, and settings. At least one key of keypad 574 can operates as a screen lock deactivating the motion detector.

FIG. 5E is an embodiment of a portable device. A portable device 590 can be a mobile phone with a touch screen 595. The touch screen 595 displays a plurality of icons 598, each of which represents a control interface. The icons 598 can be arranged in a circle. When one of the icons is manipulated, a control interface corresponding thereto is assigned as an idle screen of the portable device 590. In other words, the selected control interface which is set as the idle screen of the portable device can be the communication control interface of the communication mode, or the application control interface of one of the applications operating under the function application mode. For example, the application can be an MP3 player, PoC (Push-to-talk) terminal, radio, camera, video player, video recorder and a schedule organizer. When a control interface, such as the “FM radio” control interface is set as the idle screen, functions of the FM radio can be executed by manipulating entries shown on the idle screen (FM radio control interface).

In addition, the communication control interface or any of the application control interfaces can be displayed as an idle screen of the mobile phone in response to switching of operation mode of a mobile phone. For example, a mobile phone can be operated in 5 different operation modes: normal mode, sport mode, meeting mode, outdoor mode, and traffic mode. A user can select one of the operation modes according to the circumstance in which he/she is. The user can set a default control interface for each of the operation modes. For example, the control interface of an MP3 player or a FM radio can be set as the default control interface for the outdoor mode. When the user takes a walk outside, the outdoor mode can be selected. Accordingly, a popup window is displayed for inquiring whether the user wants the control interface of the MP3 player to be displayed as the idle screen. For example, when the mobile phone operates in the normal mode, the communication control interface is displayed as an idle screen of the mobile phone; when the mobile phone operates in the sport mode, the audio player control interface is displayed as an idle screen of the mobile phone; when the mobile phone operates in the meeting mode, the advanced calendar control interface is displayed as an idle screen of the mobile phone; when the mobile phone operates in the outdoor mode, the PoC (push to talk) client control interface is displayed as an idle screen of the mobile phone; when the mobile phone operates in the traffic mode, the FM radio control interface is displayed as an idle screen of the mobile phone.

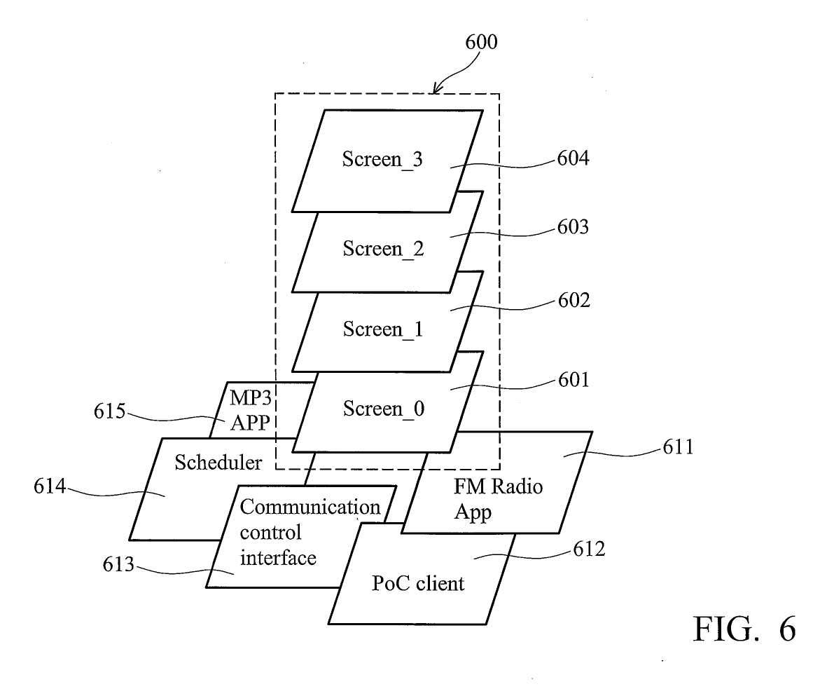

Idle screen configuration can be realized by using a “screen base” mechanism. Referring to FIG. 6, a screen history 600 is provided, wherein a root screen is within the screen history, and is displayed to be the idle screen when the mobile phone is idle. The screen history 600 comprises a root screen 601 (screen_0), and screens 602˜604 (screen_1˜screen_3). Various control interfaces, such as interfaces 611-615, can be set as candidates of root screen 601. When a control interface, such as the “FM radio” control interface 611 is set as the root screen 601, functions of the FM radio can be executed by manipulating entries shown on the idle screen (FM radio control interface). When a control interface other than the “FM radio” control interface, such as an MP3 player control interface, is set as the root screen 601, the FM radio control interface 611 previously stored as root screen 601 in the screen history 600 is substituted by the MP3 player control interface. Other control interfaces, such as a communication control interface 613 under a communication mode or one of the applications operating under the function application mode, such as PoC client control interface 612, and schedule organizer control interface 614 can be set as root screen 601 when stored as root screen 601 of screen history 600.

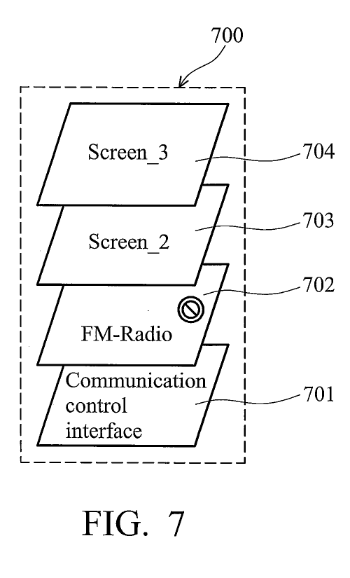

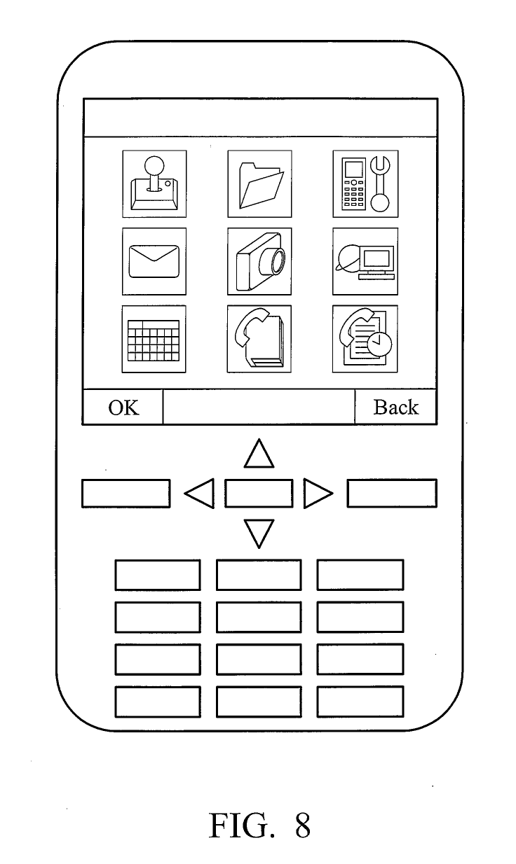

FIG. 7 shows another embodiment of idle screen configuration using a screen base mechanism. A screen history 700 is provided, comprising a communication control interface 701 under a communication mode, an application control interface 702, and screens 703˜704 pertaining to the application control interface 702. When application control interface 702 (such as an FM radio control interface) is set as an idle screen, a mark is assigned to application control interface 702, thus the displayed screen cannot go back over the marked control interface. The marked control interface, therefore, acts as an idle screen without actually substituting for the idle screen.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of operating a mobile phone implementing a plurality of functions, comprising:
providing a communication mode in the mobile phone, when operating in the communication mode, a communication control interface is configured as an idle screen when none of the functions is in use;
providing a function application mode in the mobile phone, when operating in the function application mode, an application control interface corresponding to one of the functions is configured as the idle screen when the one of the functions is in use;
receiving a first selection, directing the mobile phone to switch between the communication mode and the function application mode; and
operating the mobile phone in the communication mode or the function application mode according to the selection.

2. The method of claim 1, if the function application mode is selected, further receiving a second selection for selecting of one of the applications.

3. The method of claim 1, wherein the first selection is received via a hard key or a soft key.

4. The method of claim 1, further displaying a first icon for the first selection and at least one second icon for a second selection on a touch screen of the mobile phone, wherein each of the at least one second icon is corresponding to one of the functions, and when the function application mode is selected, the second icons are arranges in circle on the touch screen.

5. The method of claim 1, further configuring the idle screen using a screen-base mechanism, providing a screen history, wherein a root screen is within the screen history, and is displayed to be the idle screen when the mobile phone is idle.

6. The method of claim 5, further setting the root screen as the communication control interface or the application control interface according to the first selection.

7. The method of claim 5, if the function application mode is selected, further setting the root screen as one of the application control interfaces according to the second selection.

8. The method of claim 1, further configuring the idle screen using a screen-base mechanism, providing a screen history comprising a communication control interface under a communication mode, an application control interface, and screens pertaining to the application control interface.

9. The method of claim 8, when one of the application control interfaces is set as an idle screen, a mark is assigned to the application control interface, and the displayed screen go back to the marked application control interface.

10. The method of claim 1, wherein the communication control interface or one of the application control interfaces is displayed as an idle screen of the mobile phone in response to switching of operation mode of the mobile phone.

11. A mobile phone implementing a plurality of functions, comprising:
a processor operating the mobile phone in a communication mode or a function application mode, when operating in the communication mode, a communication control interface is configured as an idle screen when none of the functions is in use; when operating in the function application mode, an application control interface corresponding to one of the functions is configured as the idle screen when the one of the functions is in use;
an input device receiving a first selection of the communication mode or the function application mode; and
a display device displaying the communication control interface or the application control interface as the idle screen.

12. The mobile phone of claim 11, wherein the input device comprises a jog-dial for receiving a second selection.

13. The mobile phone of claim 11, further comprising a control device activating the jog-dial for receiving a second selection.

14. The mobile phone of claim 11, wherein the input device further comprises a switch directing the display unit to display a control interface of the communication mode.

15. The mobile phone of claim 11, wherein the input device comprises a click wheel for receiving a second selection.

16. The mobile phone of claim 11, wherein the input device comprises up/down/right/left directional keys for receiving a second selection.

17. The mobile phone of claim 11, wherein the input device comprises at least one key of a keypad of the portable device.

18. The mobile phone of claim 11, wherein the display device and the input device are implemented by a touch screen.

19. The mobile phone of claim 18, wherein the touch screen further displays a first icon for the first selection and at least one second icon for a second selection, wherein each of the at least one second icon is corresponding to one of the functions, and when the function application mode is selected, the second icons are arranges in circle on the touch screen.

20. The mobile phone of claim 11, further comprising a storage unit storing a screen history, wherein a root screen is within the screen history, and is displayed to be the idle screen when the mobile phone is idle.

21. The mobile phone of claim 20, wherein the root screen is set as the communication control interface or the application control interface according to the selection.
